(19) United States
(12) Patent Application Publication
(10) Pub. No.: US 2019/0189108 A1
(43) Pub. Date: Jun. 20, 2019

(54) TEXT MESSAGE PROCESSING METHOD AND DEVICE

(71) Applicant: HON HAI PRECISION INDUSTRY CO., LTD., New Taipei (TW)

(72) Inventor: JUNG-YI LIN, New Taipei (TW)

(21) Appl. No.: 15/876,115

(22) Filed: Jan. 20, 2018

(30) Foreign Application Priority Data
Dec. 15, 2017 (TW) 106144287

(51) Int. Cl. G10L 13/04; H04W 4/14; G10L 13/047; G10L 13/033; G06F 17/30

(52) U.S. Cl. CPC G10L 13/043; H04W 4/14; G06F 17/30778; G10L 13/033; G06F 17/30743; G10L 13/047

(57) ABSTRACT

A method for processing text messages includes receiving a text message and recording sender information. Data as to individual voice of the sender is searched for in a voice synthesis database and the text message is converted to a voice message using the data of individual voice. The voice message is then played. The application further discloses a text message processing device in which the text message processing method is applied.

### FIELD

The subject matter herein generally relates to data processing technologies, and particularly relates to a text message processing device and a text message processing method.

### BACKGROUND

Social media software, such as Wechat, QQ, can only receive a text message or a voice message once, and the receiver must look at a message window or click voice message in the message window to read the content. When a sender sends a text message, and the receiver is in inconvenient situation, such as driving a car, some important message may be missed.

### BRIEF DESCRIPTION OF THE DRAWINGS

Implementations of the present technology will now be described, by way of example only, with reference to the attached figures.

FIG. 1 is a block diagram of an exemplary embodiment of a text message processing device and a sending terminal.

FIG. 2 is a flow diagram of an exemplary embodiment of a text message processing method.

FIG. 3 is a flow diagram of an exemplary embodiment of recording data of individual voice of the text message processing method of FIG. 2.

FIG. 4 is a flow diagram of another exemplary embodiment of recording data of individual voice of the text message processing method of FIG. 2.

FIG. 5 is a block diagram of the text message processing device of FIG. 1.

FIG. 6 is another block diagram of the text message processing device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “comprising” means “including, but not necessarily limited to”; it specifically indicates open-ended inclusion or membership in a so-described combination, group, series, and the like.

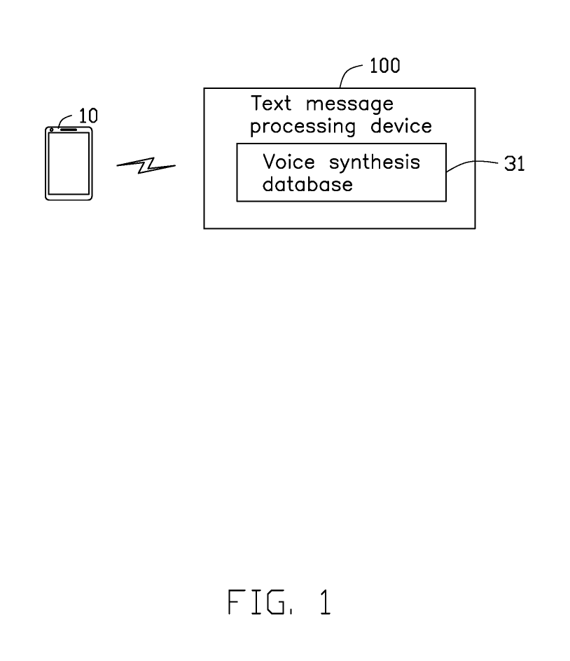

FIG. 1 illustrates a text message processing method in accordance with an exemplary embodiment. The text message processing method is used in a text message processing device 100 and converts a text message, received from a sending terminal 10, into a voice message. The voice message is then played. The text message processing device 100 stores a voice synthesis database 31. The sending terminal 10 can be mobile phone or tablet computer.

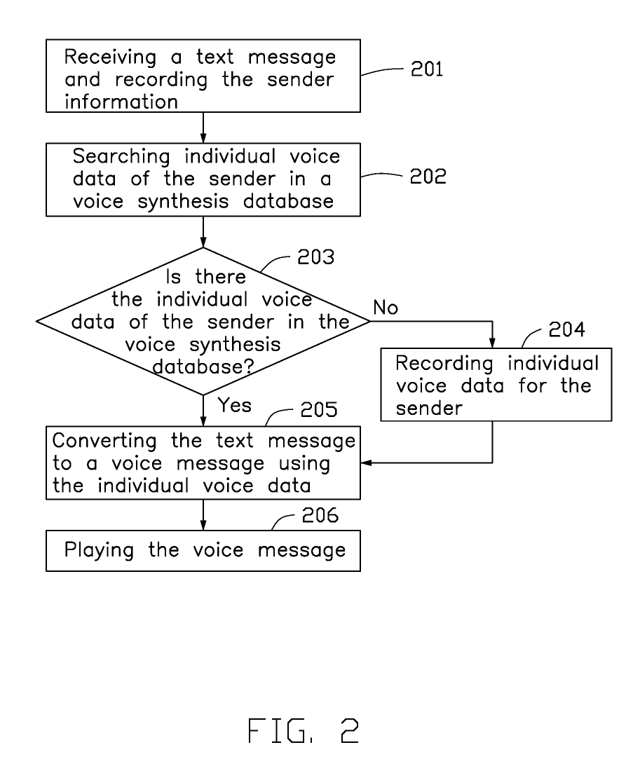

FIG. 2 is a flowchart depicting an exemplary embodiment of a text message processing method. The method is provided by way of example, as there are a variety of ways to carry out the method. The exemplary method described below can be carried out using the configurations illustrated in FIGS. 1 and 5-6, for example, and various elements of these figures are referenced in explaining the example method. Each block shown in FIG. 2 represents one or more processes, methods, or subroutines, carried out in the example method. Furthermore, the illustrated order of blocks is illustrative only and the order of the blocks can change. Additional blocks can be added or fewer blocks may be utilized, without departing from the present disclosure. The example method can begin at block 201.

At block 201, receiving a text message and recording the sender information, the sender information can comprise sender name and image of sender (head portrait).

At block 202, searching for individual voice data of the sender in the voice synthesis database 31.

At block 203, determining whether there is the individual voice data of the sender in the voice synthesis database 31; if yes, perform block 204, if not, perform block 205.

At block 204, recording individual voice data for the sender. In exemplary embodiment, the individual voice data can comprise basic language unit pronunciation of each language, for example, the basic language unit pronunciation of Chinese language comprises pronunciations for the 21 initial consonants, 37 simple or compound vowels, with 5 tones.

At block 205, converting the text message to a voice message using the individual voice data.

At block 206, playing the voice message.

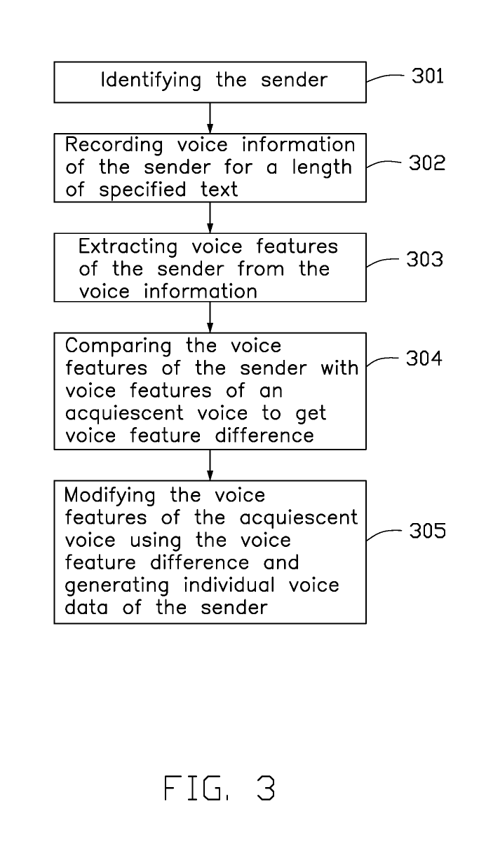

FIG. 3 is a flowchart depicting a first exemplary embodiment of the block 204. The block 204 can begin at block 301.

At block 301, identifying the sender.

At block 302, recording voice information of the sender for a length of specified text by reading the length of specified text.

At block 303, extracting voice features of the sender from the voice information.

At block 304, comparing the voice features of the sender with voice features of an acquiescent voice to get voice feature difference.

At block 305, modifying the voice features of the acquiescent voice using the voice feature difference and generating individual voice data of the sender.

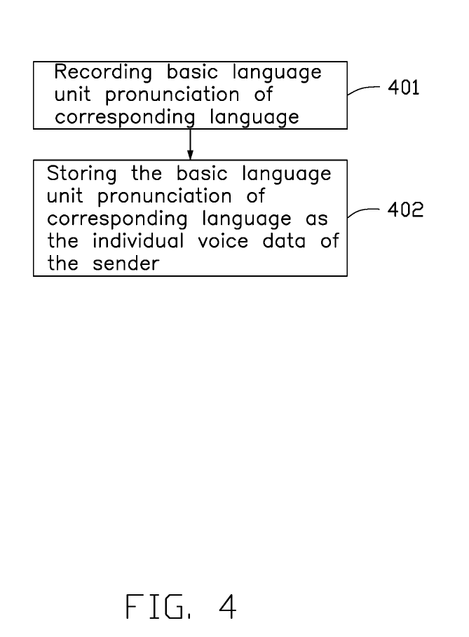

FIG. 4 is a flowchart depicting a second exemplary embodiment of the block 204. The block 204 can begin at block 401.

At block 401, recording basic language unit pronunciation of a language, for example, the basic language unit pronunciation of Chinese language comprises pronunciations for the 21 initial consonants, 37 simple or compound vowels, with 5 tones.

At block 402, storing the basic language unit pronunciation of the language as the individual voice data of the sender.

The text message processing method can further comprise setting a mode for playing. The setting playing mode comprises opening/closing automatic voice playing switch and selecting a speaker who's voice is used to convert the text message. The text message processing method can further comprise making a determination, between block 201 and block 202, as to whether the automatic voice playing switch is opened; if yes, perform block 202, if not, the text message is deemed not convertible to a voice message and the text message processing method is ended.

The speaker who's voice is used to convert the text message can be the sender or the acquiescent voice. The acquiescent voice is stored in the voice synthesis database 31. The acquiescent voice comprises basic language unit pronunciation of each language with a specific voice feature. When the text message is converted to voice message, the pronunciations corresponding to each part of language are put together consistently with a specific speed to form the voice message. The acquiescent voice can be mechanized voice, animated character voice, or a famous person's voice.

The text message processing method can further comprise storing the text message and voice message and displaying the text message and voice message in the chat window.

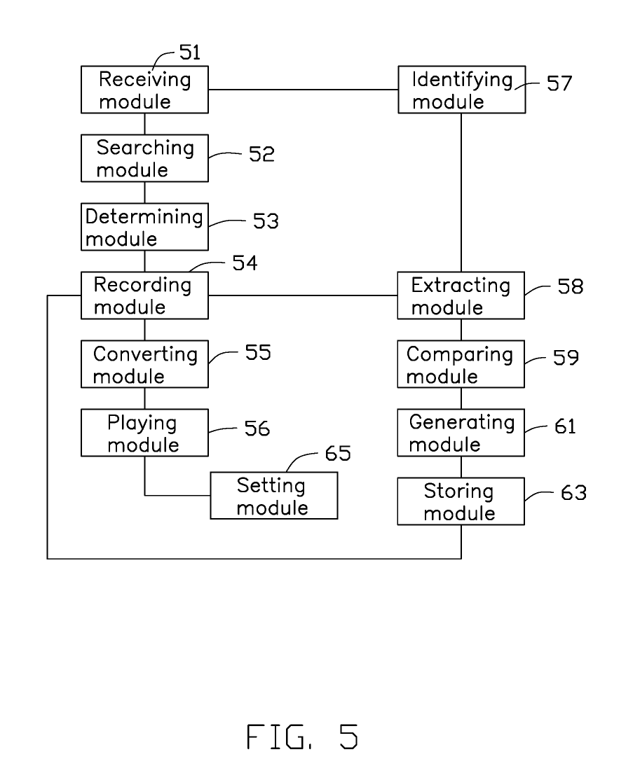

FIG. 5 illustrates that the text message processing device 100 in accordance with an exemplary embodiment can comprise a receiving module 51, a searching module 52, a determining module 53, a recording module 54, a converting module 55, and a playing module 56. The receiving module 51 receives a text message and records the sender information. The sender information can comprise sender name and head portrait. The searching module 52 is configured to search for individual voice data of the sender in the voice synthesis database 31. The determining module 53 is configured to determine such data is in the voice synthesis database 31. The recording module 54 is configured to record individual voice data for the sender. In exemplary embodiment, the individual voice data can comprise basic language unit pronunciation of each language, for example, the basic language unit pronunciation of Chinese comprises pronunciations for the 21 initial consonants, 37 simple or compound vowels, with 5 tones. The converting module 55 is configured to convert the text message to a voice message using the individual voice data. The playing module 56 is configured to play the voice message.

The text message processing device 100 can further comprise an identifying module 57, an extracting module 58, a comparing module 59, and a generating module 61. The identifying module 57 is configured to identify the sender. The recording module 54 is further configured to record voice information of the sender when reading a length of specified text. The extracting module 58 is configured to extract voice features of the sender from the voice information. The comparing module 59 is configured to compare the voice features of the sender with voice features of an acquiescent voice to obtain voice feature difference. The generating module 61 is configured to modify the voice features of the acquiescent voice using the voice feature difference and generate individual voice data of the sender.

The recording module 54 is further configured to record the basic language unit pronunciation of a language. The text message processing device 100 can further comprise a storing module 63, which is configured to store the basic language unit pronunciation of a language as the individual voice data of the sender.

The text message processing device 100 can further comprise a setting module 65, which is configured to set a playing mode. The playing mode can comprise opening/closing automatic voice playing switch and selecting speaker who's voice data used to convert the text message. When the automatic voice playing switch is opened, the text message can be converted to the voice message.

The person speaking, who's voice data used to convert the text message, can be the sender or the acquiescent voice. The acquiescent voice is stored in the voice synthesis database 31. The acquiescent voice comprises basic language unit pronunciation of each language with a specific voice feature. When the text message is converted to voice message, the pronunciations corresponding to each part of language are consistently put together with a specific speed to form the voice message. The acquiescent voice can be mechanized voice, animated character voice, or a famous person's voice.

The storing module 65 is further configured to store the text message and the voice message, and also display same in the chat interface.

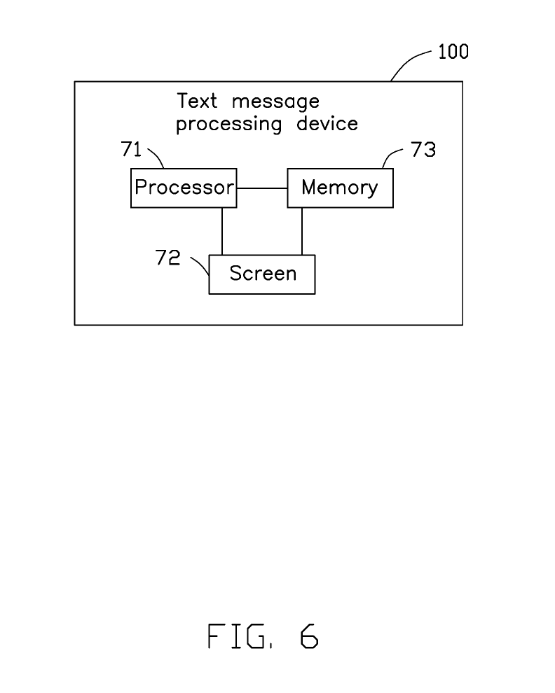

FIG. 6 illustrates that an internal structure of the text message processing device 100 in accordance with an exemplary embodiment can comprise a processor 71, a screen 72, and a memory 73. The screen 72 is configured to display the text message and the voice message. The processor 71 is configured to call out logic instruction stored in the memory 73, so as to perform the text message processing method.

The logic instruction stored in the memory 73 can be part of other software or used as an independent product. The memory 73 can store software programs or routine, or computer-performable routines, such as the routine instructions or modules corresponding to the text message processing method disclosed in the exemplary embodiment. The processor 71 performs function application and data processing by operating the software routine, instruction, and modules.

The memory 73 can comprise routine storing area and data storing area.

The routine storing area is configured to store operating system and application routine. The data storing area is configured to store data generated by the text message processing device. The memory 73 can comprise USB flash disk, mobile HDD, Read-Only Memory, Random Access Memory, diskette, and optical disk.

The text message processing device 100 can comprise a mobile terminal and a server. The server comprises the processor and the memory. The mobile terminal can be a mobile phone or a tablet computer. The processer loads and executes at least one instruction to achieve blocks or steps of the text message processing method of FIGS. 2-4. In a precise and complete implementation, the at least one instruction loaded by the processor executes the method of firstly receiving a text message and recording sender information; the sender information can comprise sender name and head portrait. Secondly, searching for individual voice data of the sender in the voice synthesis database 31 and determining whether there is the individual voice data of the sender in the voice synthesis database 31. Thirdly, recording individual voice data for the sender. Fourthly, converting the text message to a voice message using the individual voice data; and finally sending the voice message to the mobile terminal. The mobile terminal receives and plays the voice message.

In order to record individual voice data for the sender, the at least one instruction loaded by the processor identifies the sender, records voice information of the sender for a length of specified text by reading the length of specified text. Voice features of the sender are extracted from the voice information and the voice features of the sender are compared with voice features of an acquiescent voice to obtain voice feature differences. Voice features of the acquiescent voice can be modified using the voice feature differences, to generating individual voice data of the sender.

In order to record individual voice data for the sender, the at least one instruction loaded by the processor further records basic language unit pronunciation of a language and stores the basic language unit pronunciation of the language as the individual voice data of the sender.

The mobile terminal can further execute or set a playing mode, and send the set-mode data to the server. The setting playing mode comprises opening/closing automatic voice playing switch and selecting speaker who's voice data is used to convert the text message. When the automatic voice playing switch is opened, the text message can be converted to the voice message.

The processor can further execute storage of the text message and voice message and display of the text message and voice message in the chat window of in the mobile terminal.

The text message processing device 100 in a second embodiment can be a mobile terminal. The mobile phone comprises the processor and the memory. The mobile terminal can be a mobile phone or a tablet computer. The processer can execute at least one instruction to achieve blocks or steps of the text message processing method shown in FIGS. 2-4. In a concrete implementation, the at least one instruction loaded by the processor executes the method of receiving a text message and recording the sender information, the sender information can comprise sender name and head portrait. Then searching for individual voice data of the sender in the voice synthesis database 31 and determining whether such data is in the voice synthesis database 31. Data of individual voice for the sender is recorded, and the text message is converted to a voice message using the data of individual voice. Then the voice message is played.

In order to record data of individual voice for the sender, the at least one instruction loaded by the processor identifies the sender, and records voice information of the sender for a length of specified text by reading the length of specified text. Voice features of the sender are extracted from the voice information and compared with the voice features of an acquiescent voice to get voice feature differences. The voice features of the acquiescent voice are modified using the voice feature differences, to generate data of individual voice of the sender.

In order to record data of individual voice for the sender, the at least one instruction loaded by the processor also records basic language unit pronunciation of a language and stores the basic language unit pronunciation of the language as data of the individual voice of the sender.

The at least one instruction loaded by the processor can further set a playing mode, and send the set-mode data to the server. The setting playing mode comprises opening/closing automatic voice playing switch and selecting the one person who's voice data is used to convert the text message. When the automatic voice playing switch is opened, the text message can be converted to the voice message.

The at least one instruction loaded by the processor can further store the text message and voice message and display the text message and voice message in the screen of the mobile terminal.

The exemplary embodiments shown and described above are only examples.

Many details are often found in the art such as the other features of text message processing device and method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A text message processing method comprising:
receiving a text message and recording sender information;
searching individual voice data of the sender in a voice synthesis database;
converting the text message to a voice message using the individual voice data; and
playing the voice message.

2. The text message processing method of claim 1, wherein further comprising:
determining whether there is the individual voice data of the sender in the voice synthesis database; and
recording individual voice data for the sender to the voice synthesis database.

3. The text message processing method of claim 2, wherein the recording individual voice data for the sender comprising:
identifying the sender;
recording voice information of the sender;
extracting voice features of the sender from the voice information.

4. The text message processing method of claim 3, wherein the recording individual voice data for the sender further comprising:
comparing the voice features of the sender with voice features of an acquiescent voice to get voice feature difference; and
modifying the voice features of the acquiescent voice using the voice feature difference and generating individual voice data of the sender.

5. The text message processing method of claim 2, wherein the recording individual voice data for the sender comprising recording voice information of the sender by rending a length of specified text.

6. The text message processing method of claim 2, wherein the recording individual voice data for the sender comprising:
recording basic language unit pronunciation of corresponding language;
storing the basic language unit pronunciation of corresponding language as the individual voice data of the sender.

7. The text message processing method of claim 1, wherein further comprising: setting playing mode; and the setting playing mode comprises opening/closing automatic voice playing switch and selecting one who's voice data used to convert the text message.

8. The text message processing method of claim 7, wherein the one who's voice data used to convert the text message is the sender or the acquiescent voice, and the acquiescent voice comprises basic language unit pronunciation of each language with a specific voice feature.

9. The text message processing method of claim 1, wherein further comprising: storing the text message and the voice message and displaying the text message and the voice message.

10. A text message processing method comprising:
receiving a text message and recording sender information;
identifying the sender;
recording voice information of the sender;
operating the voice information to an individual voice data;
converting the text message to a voice message using the individual voice data; and
playing the voice message.

11. The text message processing method of claim 10, wherein the operating the voice information to an individual voice data comprising:
extracting voice features of the sender from the voice information;
comparing the voice features of the sender with voice features of an acquiescent voice to get voice feature difference;
modifying the voice features of the acquiescent voice using the voice feature difference and generating individual voice data of the sender; and
storing the individual voice data for the sender to a voice synthesis database.

12. A text message processing device, comprising:
a receiving module, configured to receive a text message and recording sender information;
a searching module, configured to search individual voice data of the sender in a voice synthesis database;
a converting module, configured to convert the text message to a voice message using the individual voice data; and
a playing module, configured to play the voice message.

13. The text message processing device of claim 12, wherein further comprising:
a determining module, configured to determine whether there is the individual voice data of the sender in the voice synthesis database; and
a recording module, configured to record individual voice data for the sender to the voice synthesis database.

14. The text message processing device of claim 13, wherein further comprising an identifying module and an extracting module, the identifying module is configured to identify the sender, the recording module is further configured to record voice information of the sender, and the extracting module is configured to extract voice features of the sender from the voice information.

15. The text message processing device of claim 14, wherein further comprising:
a comparing module, configured to compare the voice features of the sender with voice features of an acquiescent voice to get voice feature difference; and
a generating module, configured to modify the voice features of the acquiescent voice using the voice feature difference and generate the individual voice data of the sender.

16. The text message processing device of claim 13, wherein further comprising a storing module, the recording module is further configured to record basic language unit pronunciation of corresponding language, and the storing module is configured to store the basic language unit pronunciation of corresponding language as the individual voice data of the sender.

17. The text message processing device of claim 12, wherein further comprising a setting module, configured to set playing mode, which comprises opening/closing automatic voice playing switch and selecting one who's voice data used to convert the text message.

18. The text message processing device of claim 17, wherein the one who's voice data used to convert the text message is the sender or the acquiescent voice, and the acquiescent voice comprises basic language unit pronunciation of each language with a specific voice feature.

19. The text message processing device of claim 13, wherein further comprising a storing module, configured to store the text message and the voice message and displaying the text message and the voice message.
